(19) United States
(12) Patent Application Publication
(10) Pub. No.: US 2004/0117601 A1
(43) Pub. Date: Jun. 17, 2004

(54) General-purpose processor that can rapidly perform binary polynomial arithmetic operations

(76) Inventors: Lawrence A. Spracklen, Boulder Creek, CA (US); Sheueling Chang Shantz, Cupertino, CA (US)

Correspondence Address: HOYT A. FLEMING III, P.O. BOX 140678, BOISE, ID, 83714, US

(21) Appl. No.: 10/317,752

(22) Filed: Dec. 12, 2002

(51) Int. Cl. G06F 9/00

(52) U.S. Cl. 712/221

(57) ABSTRACT

One embodiment of the invention is a general-purpose processor. The general-purpose processor is configured to receive and execute instructions. The processor includes an integer execution unit. The processor also includes a binary polynomial execution unit.

### 1. FIELD OF THE INVENTION

The present invention relates to general-purpose processors. More specifically, the present invention relates to general-purpose processors that can rapidly perform binary polynomial arithmetic operations.

### 2. BACKGROUND

Elliptic curves are simple functions that can be drawn as gently looping lines in the (x, y) plane. An example of an elliptic curve is shown in FIG. 1. Mathematicians have studied elliptic curves for many years and have made several important findings. One such finding relates to Elliptic Curve Cryptography (“ECC”). Elliptic curves have been found to provide versions of public-key cryptographic methods that, in some cases, are faster and use smaller keys than other cryptographic methods, while providing an equivalent level of security.

The computations required to perform many ECC encryption/decryption operations involve the multiplication of polynomials with binary coefficients. Such polynomials are known as binary polynomials.

Current general-purpose processors contain an Arithmetic Logic Unit (ALU) that contains an integer execution unit and a floating point execution unit within their ALUs. As a result, while modern general-purpose processors can perform integer multiplication in one instruction, such processors typically require hundreds of instructions to perform a binary polynomial multiplication.

Thus a need exists for a general-purpose processor that can rapidly perform binary polynomial arithmetic operations such as binary polynomial multiplication.

### 3. SUMMARY OF INVENTION

One embodiment of the invention is a general-purpose processor. The general-purpose processor is configured to receive and execute instructions. The processor includes an integer execution unit and a binary polynomial execution unit. Another embodiment of the invention is a general-purpose processor that is configured to receive and execute a first instruction and a second instruction. The processor includes an integer execution unit that is configured to execute a first instruction. The execution of the first instruction performs a classical sum operation. The processor further includes a binary polynomial execution unit that is configured to execute a second instruction. The execution of the second instruction performs one or more “xor” sum operations and/or one or more “xor” division operations.

### 4. BRIEF DESCRIPTION OF THE FIGURES

FIG. 1 presents a diagram of an elliptic curve.

FIG. 2 presents a general-purpose processor.

FIG. 3 presents a method of performing binary polynomial addition.

FIG. 4 presents a method of performing binary polynomial multiplication.

FIG. 5 presents a method of performing binary polynomial division.

FIG. 6 presents another general-purpose processor.

FIG. 7 presents an arithmetic logic unit.

FIG. 8 presents a schematic representation of two multiplication instructions.

FIG. 9 presents another arithmetic logic unit.

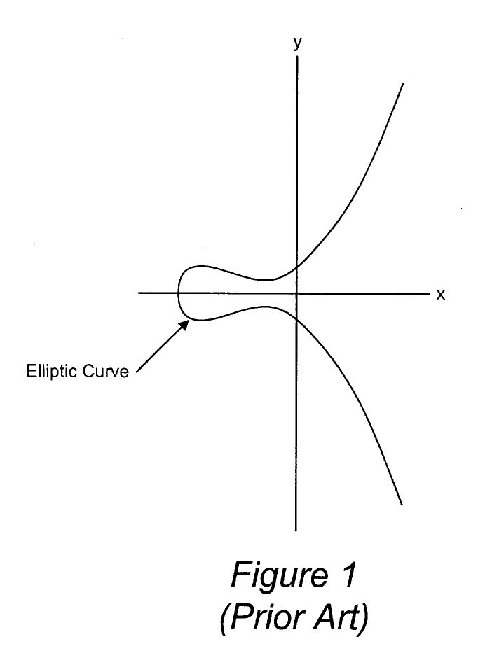

### 5. DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

5.1 General-Purpose Processor with a Binary Polynomial Execution Unit

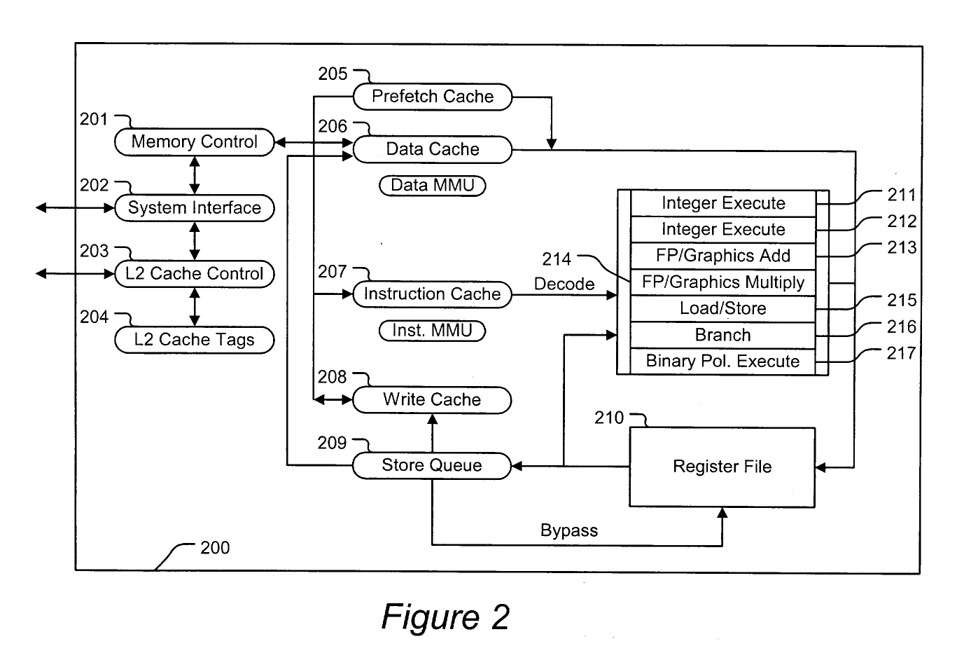

FIG. 2 presents a high level diagram of a general-purpose processor 200 that can rapidly perform binary polynomial operations.

The general-purpose processor 200 may include a number of units that are present on conventional processors such as: a memory control unit 201; a system interface unit 202; an L2 cache control unit 203; an L2 cache tags unit 204; a prefetch cache unit 205; a data cache unit 206; an instruction cache unit 207; a write cache unit 208; a store queue unit 209; and a register file 210. The units may be coupled as shown in FIG. 2. Alternatively, some or all the units may be coupled as is known by those skilled in the processor art.

The general-purpose processor 200 may also contain a number of different execution units. For example, the general-purpose processor 200 may include one or more integer execution units 211 and 212. The general-purpose processor 200 may also include one or more floating point execution units 213 and 214. In some embodiments of the invention, the floating point execution units 213 and 214 may process single instruction multiple data (SIMD) instructions that are useful in accelerating multimedia, image processing and/or network applications. Examples of such SIMD instructions include arithmetic and logical instructions, comparison instructions, format conversion instructions, data misalignment handling instructions, data access instructions, fast 3D array access instructions, and data manipulation instructions.

The general-purpose processor 200 may also include one or more load/store units 215 and/or branch units 216, as are known by those skilled in the processor art.

As shown in FIG. 2, the general-purpose processor 200 may also include one or more binary polynomial execution units 217, which are discussed in Section 5.3 below.

5.2 Finite Field Arithmetics

A finite field, which is known as a Galois Field (“GF”), is a field with a finite number of elements. The finite field GF(2⁸) consists of 2⁸ (256) different numbers (0 to 255). A finite field can be represented as a polynomial. For example, byte (10100011) can be represented as:

1*x⁷+0*x⁶+1*x⁵+0*x⁴+0*x³+0*x²+1*x¹+1*x⁰=x⁷+x⁵+x+1

Note that the coefficients of this polynomial, which represents a byte or GF(2⁸), can only be one or zero.

5.2.1 Polynomial Addition

The “classical” method of adding two polynomials involves adding the coefficients of like powers of x as shown below:

(x⁶+x⁴+x+1)+(x⁷+x⁵+x+1)=x⁷+x⁶+x⁵+x⁴+x²+2x+2

However, such a method results in some coefficients not being one or zero. Thus, the “classical” method of addition does not result in an element of the original finite field.

In order to ensure that the polynomial resulting from the addition of two polynomials contains only binary coefficients, the “xor” (exclusive or) operator (⊕) is utilized. Because the “xor” sum of two ones is equal to zero (1 xor 1=0), the resulting polynomial will only contain binary coefficients. Thus, using this method:

(x⁶+x⁴+x²+x+1)⊕(x⁷+x⁵+x+1)=x⁷+x⁶+x⁵+x⁴+x²

Because each of the coefficients of the result is binary, the result is an element of the original finite field GF(2⁸).

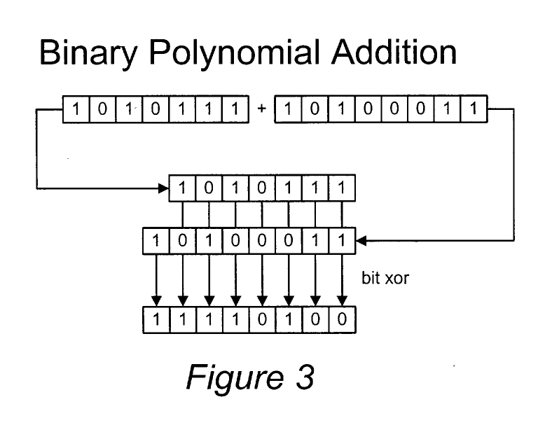

As shown in FIG. 3, the above-described “xor” binary polynomial addition can be performed by performing a bit-wise “xor” operation upon two bytes that contain binary polynomial coefficients.

5.2.2 Polynomial Multiplication

The “classical” method of multiplying two polynomials involves multiplying each summand of the first polynomial by every summand of the second polynomial and adding the coefficients of like powers. For example:

(x⁶+x⁴+x²+x+1)*(x⁷+x⁵+x+1)=x¹³+2x¹¹+2x⁹+x⁸+3x⁷+2x⁶+2x⁵+x⁴+x³+2x²+2x+1

However, such a method results in some coefficients not being one or zero. Thus, such a method does not result in an element of the original finite field.

By utilizing the above-described “xor” sum method to add polynomials of like powers (even coefficients→0, odd coefficients→1), the result of the above multiplication would be: x¹³+x⁸+x⁷+x⁴+X³+1. While the resulting coefficients are binary, the resulting polynomial has a degree greater than 7. Thus, the polynomial is not within the finite field GF(2⁸). However, the resulting polynomial can be transformed into the finite field GF(2⁸) by the modulo division described in Section 5.2.3 below.

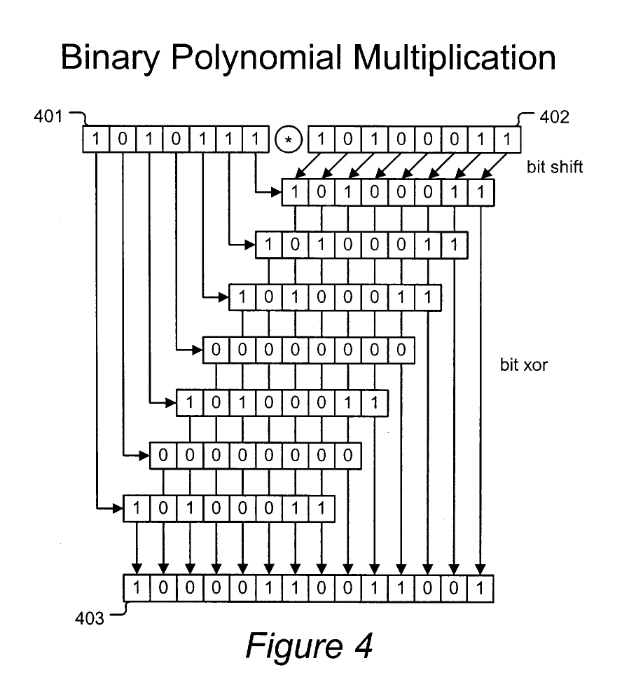

As shown in FIG. 4, the above “xor” sum multiplication can be performed by shifting the second byte 402 one bit to the left for every bit in the first byte 401. As shown in FIG. 4, if a bit in the first byte 401 is 0, then a 0-byte is used instead of the second byte 402. After the above multiplications are performed, an “xor” operation is performed on the resulting bits. The result 403 contains only binary coefficients.

5.2.3 Polynomial Division

The “classical” method of dividing two polynomials involves dividing the greatest power of the numerator by the greatest power of the denominator. The result of the division is then multiplied by the complete denominator and subtracted from the numerator. The result is a new numerator. This procedure is repeated until the greatest power of the new numerator has become less than the greatest power of the denominator. The final numerator is the remainder of this modulo operation. Utilizing the classical method of division:

(x¹³+x⁸+x⁷+x⁴+x³+1)/(x⁸+x⁴+x³+x+1)=x⁷+x⁶+2x⁴+x³+x²+x+1

By applying the above-described “xor” rules (even coefficients→0, odd coefficients→1) to the final numerator, the final numerator (x⁷+x⁶+x³+x²+x+1) is a member of the finite field GF(2⁸).

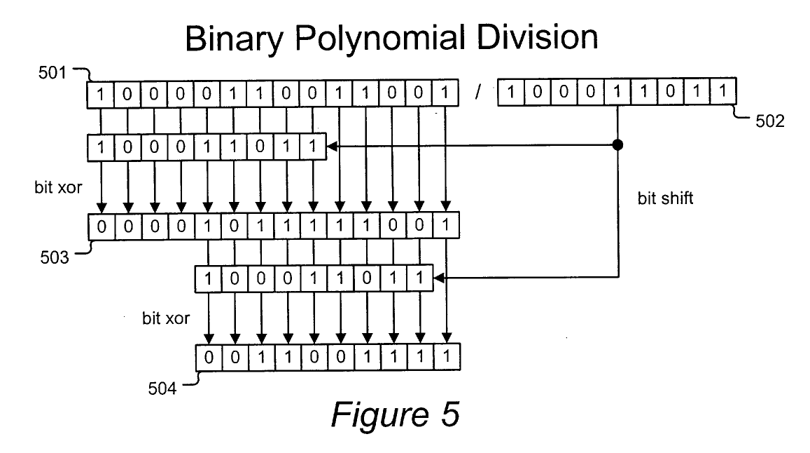

As shown in FIG. 5, the above division can be accomplished by bit-wise shifts and “xor” operations. First, the denominator 502 is shifted to the left until its most significant bit matches the most significant bit of the numerator. Then, a subtraction is performed using the “xor” operation. The result of the subtraction is a new, smaller numerator 503. The denominator 502 is again left shifted until its most significant bit matches the most significant bit of the new, smaller numerator 503. Then, another subtraction is performed using the “xor” operation. The result of the subtraction is the final numerator 504.

5.3. Binary Polynomial Execution Unit

Returning again to FIG. 2, in some embodiments of the invention, the general-purpose processor 200 includes one or more binary polynomial execution units 217. The binary polynomial execution unit 217 can include hardware for accelerating binary polynomial addition, subtraction, multiplication and/or division. For example, the binary polynomial execution unit 217 may include hardware that can rapidly perform the “xor” operations and/or bit-wise shift operations described above.

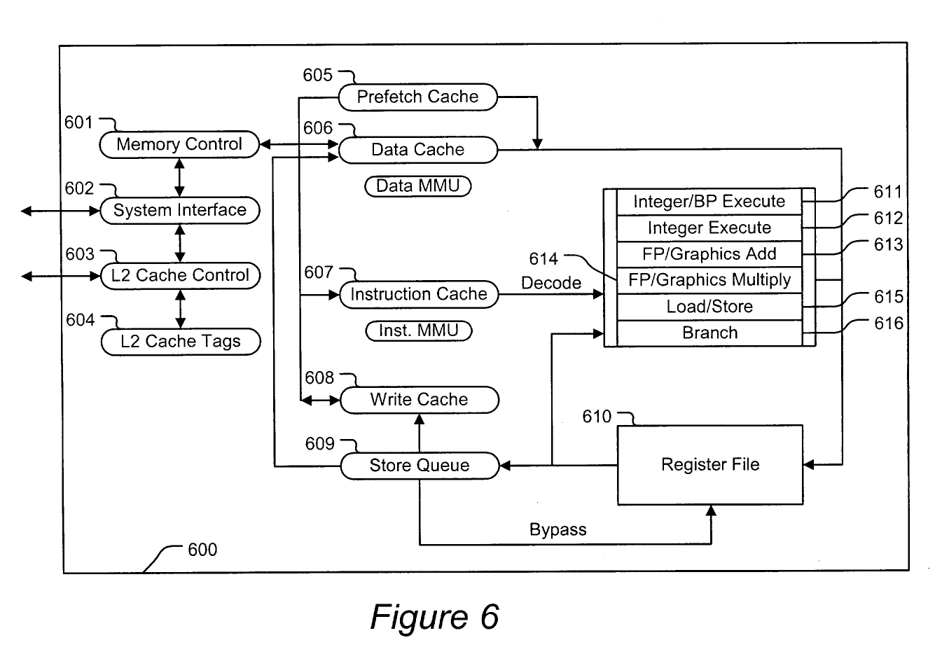

In some embodiments of the invention, such as shown in FIG. 2, the binary polynomial execution unit 217 is separate from the integer execution unit. In other embodiments, such as shown in FIG. 6, the binary polynomial execution units are included within an integer execution unit 611. In such embodiments of the invention, the integer execution unit 611 permits “classical” carry operations or “xor” carry operations. By configuring the integer execution unit 611 to utilize “classical” carry operations or “xor” carry operations, the integer execution unit 611 can efficiently perform both integer and binary polynomial arithmetic functions. Thus, when operating in a first mode, the integer execution unit 611 could perform integer multiplication and when operating in a second mode, the integer execution unit 611 could perform binary polynomial multiplication.

In order to efficiently perform integer and binary polynomial operations, the general-purpose processor 200 and/or 600 may utilize extended instruction sets. For example, the general-purpose processor 200 and/or 600 may include an instruction, such as mulx, that returns the least significant bits of a product produced when “classically” multiplying two integers. The general-purpose processor 200 and/or 600 may also include an instruction, such as mulxhi, that returns the result of the most significant bits of a product produced when “classically” multiplying two integers. The general-purpose processor 200 and/or 600 may further include an instruction, such as bmulx, that returns the least significant bits of a product produced when multiplying two binary polynomials as described above. The general-purpose processor 200 and/or 600 may still further include an instruction, such as bmulxhi, that returns the upper bits of a product produced when multiplying two binary polynomials as described above. A schematic representation of the bmulx and bmulxhi instructions is shown in FIG. 8. The general-purpose processor 200 and/or 600 could also utilize extended instructions for returning the results of other binary polynomial arithmetic operations such as binary polynomial addition, subtraction, and division.

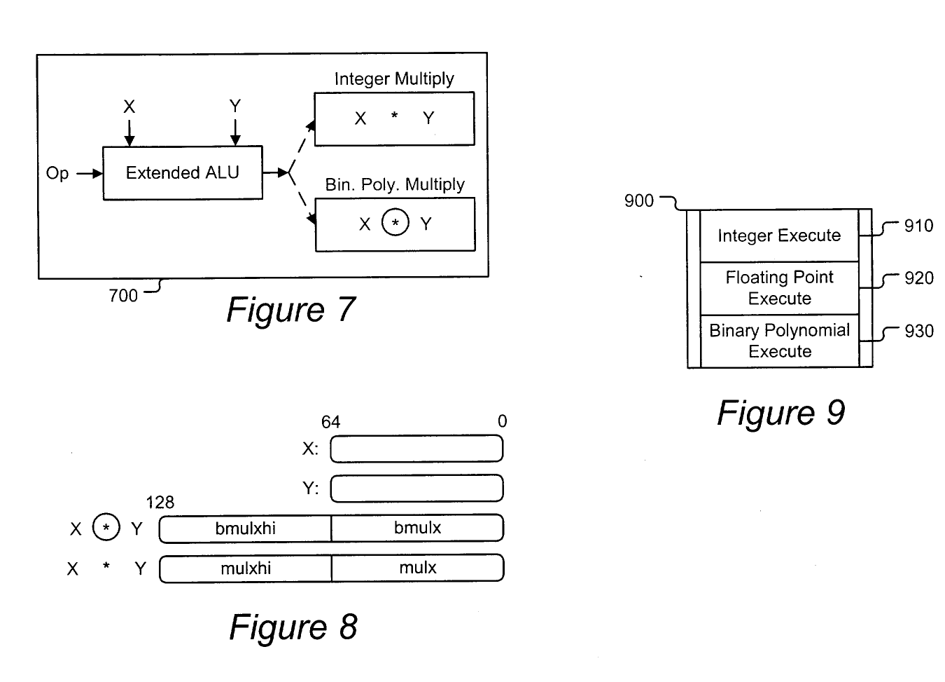

In summary, one embodiment of the invention is a general-purpose computer that contains an Arithmetic Logic Unit (ALU) which can perform both integer multiply and binary polynomial multiply operations. A schematic representation of such an ALU is shown in FIG. 7. In some embodiments of the invention, the ALU 700 can return either the upper or lower half of the computed product for integer and binary polynomial multiplication as shown in FIG. 8. Another embodiment of the invention is a general-purpose computer that can execute binary polynomial instructions such as the above-described bmulx and bmulxhi instructions. Yet another embodiment of the invention is an ALU, as shown in FIG. 9, that includes an integer execution unit 910, a floating point execution unit 920, and a binary polynomial execution unit 930. Still another embodiment of the invention is an ALU that offers a broad set of arithmetic operations including integer, floating point and binary polynomial operations. Such an ALU would utilize an extended set of instructions that would enable programming code to efficiently utilize integer, floating point and binary polynomial instructions.

By utilizing a general-purpose processor with hardware for accelerating binary polynomial arithmetic operations, public-key cryptographic methods utilizing elliptic curves can be rapidly performed.

5.4 Conclusion

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

It is claimed:

1. A general-purpose processor configured to receive and execute instructions, the processor comprising:
a) an integer execution unit; and
b) a binary polynomial execution unit.

2. The general-purpose processor of claim 1, wherein the binary polynomial execution unit includes hardware for accelerating binary polynomial addition.

3. The general-purpose processor of claim 1, wherein the binary polynomial execution unit includes hardware for accelerating binary polynomial subtraction.

4. The general-purpose processor of claim 1, wherein the binary polynomial execution unit includes hardware for accelerating binary polynomial multiplication.

5. The general-purpose processor of claim 1, wherein the binary polynomial execution unit includes hardware for accelerating binary polynomial division.

6. The general-purpose processor of claim 1, wherein the binary polynomial execution unit includes hardware for accelerating binary polynomial addition, subtraction, multiplication, and division.

7. The general-purpose processor of claim 1, wherein the binary polynomial execution unit is operable to execute a single instruction that results in the performance of an “xor” sum arithmetic operation.

8. The general-purpose processor of claim 1, wherein the binary polynomial execution unit is operable to execute a single instruction that results in the performance of two or more “xor” sum arithmetic operations.

9. A general-purpose processor configured to receive and execute a first instruction and a second instruction, the processor comprising:
a) an integer execution unit that is configured to execute a first instruction, the execution of the first instruction performing a classical sum operation; and
b) a binary polynomial execution unit that is configured to execute a second instruction, the execution of the second instruction performing an “xor” sum operation.

10. The general-purpose processor of claim 9, wherein the execution of the second instruction includes performing a binary polynomial multiplication operation.

11. The general-purpose processor of claim 9, wherein the execution of the second instruction includes performing two or more “xor” sum operations.

12. A general-purpose processor configured to receive and execute a first instruction and a second instruction, the processor comprising:
a) an integer execution unit that is configured to execute a first instruction, the execution of the first instruction performing a classical sum operation; and
b) a binary polynomial execution unit that is configured to execute a second instruction, the execution of the second instruction performing an “xor” subtraction operation.

13. The general-purpose processor of claim 12, wherein the execution of the second instruction includes performing a binary polynomial division operation.

14. The general-purpose processor of claim 12, wherein the execution of the second instruction includes performing two or more “xor” subtraction operations.

15. A general-purpose processor configured to receive and execute instructions, the processor comprising:
a) an integer execution unit, the integer execution unit operable in a first mode and a second mode, the integer execution unit, when operating in the first mode, being operable to execute a first instruction that performs a classical sum operation, the integer execution unit, when operating in the second mode, being operable to execute a second instruction that performs an “xor” sum operation.

16. The general-purpose processor of claim 15, wherein the execution of the second instruction includes performing two or more “xor” sum operations.

17. The general-purpose processor of claim 15, wherein the integer execution unit, when operating in the second mode, is operable to execute a third instruction that performs an “xor” subtraction operation.

18. The general-purpose processor of claim 15, wherein the integer execution unit, when operating in the second mode, is operable to execute a third instruction that performs two or more “xor” subtraction operations.

19. The general-purpose processor of claim 15, wherein the integer execution unit, when operating in the second mode, is operable to execute a third instruction that performs an “xor” multiplication operation.

20. The general-purpose processor of claim 15, wherein the integer execution unit, when operating in the second mode, is operable to execute a third instruction that performs an “xor” division operation.
